(19) United States
(12) Patent Application Publication
(10) Pub. No.: US 2011/0163085 A1
(43) Pub. Date: Jul. 7, 2011

(54) Method for Soldering Contact Wires to Solar Cells

(75) Inventors: Jens Kalmbach, Pfalzgrafenweiler (DE); Patrik Müller, Reute (CH); Gerhard Klingebiel, VS-Villingen (DE)

(73) Assignee: Schmid Technology Systems GmbH, Niedereschach (DE)

(21) Appl. No.: 13/036,665

(22) Filed: Feb. 28, 2011

Related U.S. Application Data
(63) Continuation of application No. PCT/EP2009/006268, filed on Aug. 28, 2009.

(30) Foreign Application Priority Data
Aug. 29, 2008 (DE) DE 102008046330.2

(51) Int. Cl. B23K 1/002; B23K 31/12; B23K 1/20; B23K 26/00

(52) U.S. Cl. 219/616; 228/101; 228/102; 228/262.9; 219/121.85

(57) ABSTRACT

In a method for soldering contact wires to a side of a solar cell for producing the electrical contact-making, the solar cells have at least one metallic strip-shaped region. A contact wire is soldered onto the latter for the electrical connection of the solar cell, wherein the soldering duration or the duration of the energy input externally onto the soldering region is very short and is less than 800 ms.

### CROSS-REFERENCE TO RELATED APPLICATIONS

This application is a continuation of PCT Application No. PCT/EP2009/006268, filed Aug. 28, 2009, and claims priority to DE 10 2008 046 330.2 filed Aug. 29, 2008, the disclosures of which are hereby incorporated by reference in their entirety.

### FIELD OF APPLICATION AND PRIOR ART

The invention relates to a method for soldering contact wires to a solar cell such as is carried out in particular during the assembly together with electrical interconnection of a plurality of solar cells to form a composite assembly or a module.

In photovoltaics, the trend in technological development is constantly toward lowering costs and increasing the efficiency. During the electrical connection of solar cells to form a solar module, chains or so-called stringers are predominantly used. In said stringers, the cells are soldered with contact wires to form stringers by means of a soldering process. Contact soldering is predominantly used during this soldering process. In this case, the solar cells are preheated and the soldering tin of the contact wire is soldered by means of a heating stamp through the solar cell with a respective connection at the top and bottom.

In order to reduce mechanical stresses, brought about by the different expansion coefficients of the materials to be connected, and thus to avoid cell fracture, the cells should be preheated. The required preheating of the cell, under certain circumstances almost up to the liquidus temperature of the soldering tin, and the subsequently soldering operation can bring about a fracture of the solar cell in an unfavourable case, particularly if said cell is already weakened by microcracks.

EP 1 748 495 A1 discloses a corresponding method described above. This method uses induction soldering, that is known per se. Furthermore, here the solar cell is indeed preheated, in which case heating plates, or infrared or hot air heating systems can be provided for preheating.

### OBJECT AND SOLUTION

The invention is based on the object of providing an above-mentioned method by means of which disadvantages of the prior art can be avoided and, in particular, mechanical stresses in the solar cell as a result of the preheating or the soldering operation itself can be reduced as far as possible or even completely eliminated.

This object is achieved by means of a method comprising the features of claim 1. Advantageous and preferred configurations of the invention are the subject matter of the further claims and are explained in more detail below. The wording of the claims is incorporated by express reference in the content of the description.

It is provided that the solar cell has at least one metallized contact region, which is advantageously strip-shaped. Said contact region can also be metallic instead of metallized, that is to say a metal part rather than a metallized coating of the solar cell. A contact wire is soldered onto said metallized or metallic contact region in order to electrically connect the solar cell. According to the invention, the soldering duration or the duration of the energy input externally onto the soldering region, that is to say in particular onto the contact wire, is less than 800 ms. The soldering duration or the energy input duration is advantageously even less than 500 ms, for example 300 ms to 400 ms. This has the advantage that within this short time, although the soldering tin or the soldering material can be caused to melt by means of a correspondingly high energy input in order to produce the soldering connection between contact wire and metallized or metallic contact region, at the same time overall heating to such a great extent that the solar cell becomes too hot in the soldering region or close to the soldering region or exceeds a temperature of 100° C. to 120° C., for example, does not take place.

In one advantageous configuration of the invention, the energy input for soldering takes place with a predetermined temperature profile over time. Such a temperature profile is manifested particularly advantageously such that the energy input or thus the temperature at the soldering region or of the soldering tin at the beginning of the soldering operation rises very sharply to a maximum temperature. After this maximum temperature has been reached, it can be briefly maintained and should then fall relatively rapidly again, such that the soldering tin is as it were heated very rapidly to melting point. A further, albeit lower energy input is then additionally effected in order to produce the flowing of the soldering tin and also a connection to the contact region. Therefore, after the maximum temperature has been reached, a lower temperature suffices for continuing the soldering operation and reliably and permanently producing the soldering connection. The temperature can fall to approximately 60% of the maximum temperature. The energy input then stops again relatively abruptly and the soldering operation or the energy input is rapidly ended by a rapid fall in the temperature without energy input, with the result that the soldering tin can solidify and the soldering connection is concluded.

In order to achieve such a temperature profile which is controlled by means of the energy input or the magnitude and duration thereof, the soldering operation or the energy input is advantageously a regulated process, that is to say not just the controlled following of a predetermined profile for the energy input or the like. For this purpose, the temperature development at the soldering region can be monitored by means of a temperature measuring device, advantageously a pyrometer. This temperature is fed back as a manipulated variable to the energy generation for precise regulation, with the result that the energy input is indeed regulated in such a way that a predetermined profile is achieved, in particular for achieving the prescribed temperature profile. In the case of this temperature profile care should be taken to ensure that, of course, after the beginning and after the stopping of the energy input, the temperature does not rise and fall abruptly, but rather gradually or with a delay.

In one configuration of the invention, it is advantageously provided that the solar cell is preheated before the soldering operation in a manner similar to that in the prior art. However, preheating is advantageously effected to a temperature of less than 80° C. Particularly advantageously, the solar cell is preheated to approximately the average working temperature of subsequent operation, since it is adequately designed for this loading and so no mechanical stresses are produced by the connection at this temperature. This can be for example somewhat less than 65° C. Mechanical stresses or loadings of the solar cell as a result of the preheating itself are thus avoided. At the same time, of course, the soldering operation can be improved and the soldering duration can be reduced as a result of the effect of the preheating.

Preheating of the solar cell before soldering can be effected in a conventional manner. The preheating primarily also serves to ensure that the soldering connection is as good as possible, since the solder then flows sufficiently well on the metallized or metallic region. The solder melting point is approximately 200° C., depending on the soldering tin used. If lead-free soldering tin is intended to be used, then the solder melting point is approximately 30° C. to 40° C. higher again.

In a further configuration of the invention, it can be possible for a certain cooling to be performed after the end of the energy input into the soldering region. This can be achieved for example by blowing on cooling air or the like. Although the cooling effect is only limited here, it nevertheless still manifests a certain effect. Thus, the propagation of the heat into the solar cell, which is regarded as harmful, can be avoided.

Firstly, it is possible for the energy input to be effected by induction during the soldering operation, that is to say for the energy input to be induction soldering as in the prior art mentioned above. The short times and high energy inputs according to the invention can thus be achieved.

As an alternative to induction soldering, the energy input during the soldering operation can be effected by means of a laser, which likewise enables a very fast and sufficiently high energy input. In this case, a light spot of the laser preferably projects laterally beyond the contact wire and irradiates either the somewhat wider metallized or metallic contact region or the solar cell itself. It is thereby possible to achieve a further preheating or compensation of the temperature difference between the mid point of the soldering region, on the one hand, and the surrounding solar cell, on the other hand. By way of example, the diameter of the light spot can be approximately twice as large as the width of the irradiated contact wire, such that said light spot heats the solar cell in each case approximately by a quarter of its diameter or the corresponding reference circle area.

In a further configuration of the invention, in the case of an above-mentioned larger light spot of the laser, it is possible for the laser to be defocused in its edge region, in particular in an edge region of 10% to 50% and advantageously approximately 30% of its diameter. This is intended to be the edge region which projects laterally beyond the contact wire, as described above, and irradiates the solar cell itself. As a result of the defocusing of the laser in said edge region, the energy input therein can be smaller and, consequently, lie below the amount of energy input required for the soldering melting point, with the result that as it were less heating is performed here. An equalization of the temperature distribution and hence the occurrence of mechanical stresses can thus be avoided.

It can be provided that the metallic or metallized strip-shaped contact region of the solar cell to which the contact wire is soldered is elongated, in particular passes over the entire length of the solar cell. The contact wire is fixedly soldered thereto at a plurality of locations, for example two or three points, in particular in each case at a distance of 1 cm to 2 cm. These distributed soldering points suffice for a sufficiently good mechanical and electrical connection.

A tin-plated copper wire can be provided as the contact wire. In particular, it can be provided directly with soldering tin, such that the separate supply is obviated.

The contact wire is advantageously a flat wire. It can have a width a number of times greater than its thickness. By way of example, the width can lie between 1 mm and 3 mm, advantageously between 1.3 mm and 2.5 mm. Its thickness can be approximately one twentieth to one tenth of the width.

These and further features emerge not only from the claims but also from the description and the drawings, wherein the individual features can be realized in each case by themselves or as a plurality in the form of subcombinations in an embodiment of the invention and in other fields and can constitute advantageous and inherently protectable embodiments. Exemplary embodiments of the invention are illustrated in the drawings and are explained in more detail below.

### BRIEF DESCRIPTION OF THE DRAWINGS

An exemplary embodiment is illustrated schematically in the drawings and is explained in more detail below. In the drawings:

FIG. 1 shows two solar cells electrically connected to one another by means of contact wires, in plan view,

FIG. 2 shows a side view of the two solar cells from FIG. 1 with preheating and a laser for producing the soldering connection,

FIG. 3 shows an enlarged plan view of the laser spot in the soldering region, and

FIG. 4 shows one possible profile of the energy input over time.

### DETAILED DESCRIPTION OF THE EXEMPLARY EMBODIMENT

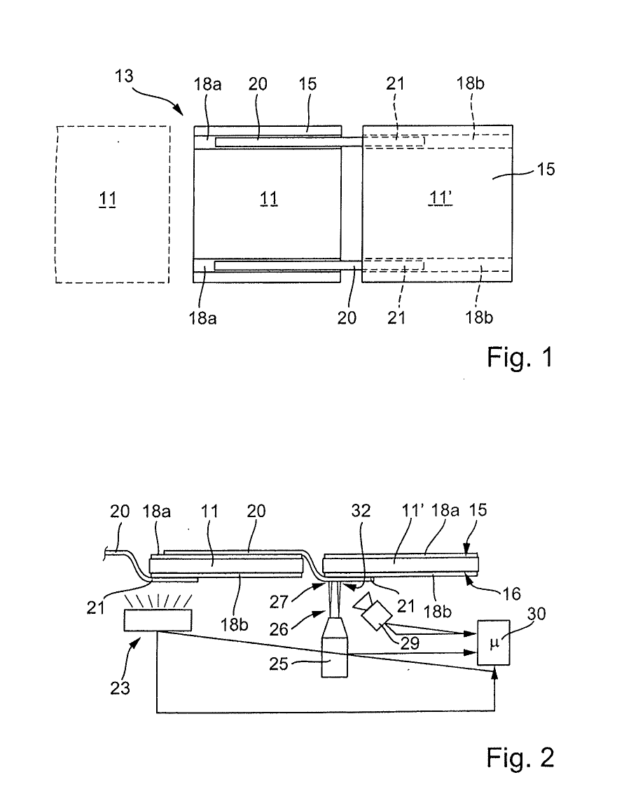

FIG. 1 illustrates in plan view a first solar cell 11 and on the right alongside the latter a second solar cell 11′. These two solar cells 11 and 11′, possibly also with further solar cells (not illustrated) already connected or yet to be connected, are formed as a chain 13 or so-called stringer. A completely interconnected solar module is produced from a plurality of such chains 13 in parallel with one another, as is known per se. In conjunction with FIG. 2 it can be seen that the solar cells 11 and 11′ have a top side 15 and an underside 16.

The top side 15 bears two narrow strip-shaped contact regions 18a, which are produced in a conventional manner by a metal coating on the solar cell. There can also be three of such contact regions. Corresponding metal-coated contact regions 18b are provided on the underside 16, said contact regions likewise running over the entire length of the solar cell 11 and 11′.

The solar cells 11 and 11′ are at a distance of a few millimetres from one another. Contact wires 20 run over the majority of the length of the upper contact regions 18a of the solar cell 11 and are then bent away downward in the interspace so as to have an overhang 21 again with a parallel course. Said overhang 21 is approximately one third as long as the contact wire 20 bearing on the top side 15.

The overhang 21 bears on the left-hand ends of the lower contact regions 18b of the solar cell 11′. The soldering connection is performed here, as will be explained in greater detail below.

FIG. 2 illustrates a preheating system 23, which, in a manner known per se, preheats the underside 16 of the solar cell 11′ at which the soldering takes place to a temperature mentioned in the introduction. The preheating system 23 can be embodied in a conventional manner, for example an IR radiant heater or the like.

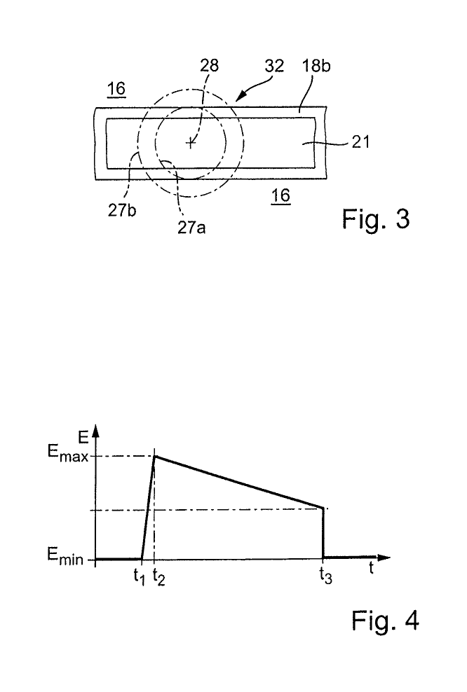

After the preheating by means of the preheating system 23, the soldering operation is carried out by means of a laser 25 and the laser beam 26 thereof or the laser spot 27. For this purpose, the laser spot 27 lies in the sok dering region 32, as can be gathered from the enlarged view in FIG. 3. The soldering operation is monitored with regard to the temperature that arises, by means of a pyrometer 29. For this purpose, preheating system 23, laser 25 and pyrometer 29 are connected to a controller 30, which controls and simultaneously monitors or regulates the individual components and the entire soldering operation.

As was described in the introduction, it can be seen in FIG. 3 that there is an outer laser spot region 27b, which is illustrated in a dash-dotted manner. It overlaps by a good portion not only the contact wire 20 or the overhang 21 thereof, but even the lower contact region 18b. Furthermore, an inner laser spot 27a is provided, which is illustrated in a dashed manner and the diameter of which is indeed likewise greater than the width of the overhang 21 of the contact wire 20, but lies approximately in the region of the width of the lower contact region 18b. In this case, the laser axis 28 is aligned precisely with the centre of the overhang 21.

In the region of the inner laser spot region 27a, such a high energy input is effected by the laser 25 that a soldering takes place here in the soldering region 32, that is to say for example that the surface of the soldering tin forming the overhang 21 melts and enters into a soldering connection with the lower contact region 18b. For the heating of the latter, the inner laser spot region 27 indeed also extends over the width of the overhang 21 for corresponding heating.

The outer laser spot region 27b effects heating primarily also of the underside 16 of the solar cell 11′ and also of the depth of the material, in order to avoid an excessively abrupt temperature transition between the rest of the solar cell 11′ and the soldering region 32. This is therefore an effect which approximately corresponds to that of the preheating and additionally supports the latter.

FIG. 4 illustrates one possible manifestation of the energy input E over time t. The soldering operation begins at the instant t1, the quantity of energy rising very sharply in a very short time up to the value Eₘₐₓ. This can take place in a few ms; the laser 25 can possibly even start immediately with full power, that is to say Eₘₐₓ. The maximum energy input Eₘₐₓ is reached at the instant t2, shortly after t1, for example after 10 ms. From that point, the energy input E falls again, to be precise down to a value Eₘᵢₙ at the instant t3. The fall can either be approximately linear or else over- or underproportional. At the instant t3, the energy input E stops as rapidly as possible and the soldering operation or at least the energy input is ended. As the temperature subsides further, the soldering operation can come to an end as a result of a solidification of the soldering tin. The duration of the soldering operation between t1 and t3 can be for example the 500 ms as mentioned in the introduction, or even less than that. Although a temperature that arises as a result of the soldering operation in the soldering region 32 is not illustrated, it is rather similar in profile to the profile of the energy input E, in each case with a delay. It therefore rises significantly more slowly than the energy input E, but then also falls somewhat more slowly or falls after the instant t3 indeed to a somewhat greater degree than before, but in the manner of a decaying curve.

Such a predetermined temperature profile can represent as it were the regulated variable for the controller 30 in the soldering region 32. The controller 30 monitors the following of this temperature profile by means of the pyrometer 29 with possible correction intervention by way of the energy input E.

It becomes clear from the description above, this soldering method is particularly suitable for punctiform soldering regions 32, in other words not continuous soldering.

1. A method for soldering contact wires to solar cells on one side of said solar cell, wherein said solar cells have at least one metallized strip-shaped contact region onto which a contact wire is soldered for an electrical connection of said solar cell, wherein a soldering duration or a duration of an energy input from external onto a soldering region is less than 800 ms.

2. The method according to claim 1, wherein said soldering duration or said duration of said energy input is less than 500 ms.

3. The method according to claim 1, wherein said energy input for said soldering takes place with a predetermined temperature profile over time.

4. The method according to claim 3, wherein said energy input or said temperature at said soldering region at a beginning of said soldering operation rises very sharply to a maximum temperature and then slowly falls, wherein an end of said soldering operation or of said energy input is then reached.

5. The method according to claim 4, wherein said energy input or said temperature at said soldering region falls to approximately 60% of said maximum temperature.

6. The method according to claim 1, wherein said soldering operation or said energy input is a regulated process, wherein said temperature development at said soldering region is monitored by means of a pyrometer and is fed back as manipulated variable for a precise regulation of said energy generation or of said energy input into said soldering region according to a predetermined profile.

7. The method according to claim 1, wherein said solar cell is preheated.

8. The method according to claim 7, wherein said solar cell is preheated to a temperature of less than 80° C. before said soldering operation.

9. The method according to claim 1, wherein said energy input or said soldering operation is effected by induction soldering.

10. The method according to claim 1, wherein said energy input or said soldering operation is effected by means of a laser.

11. The method according to claim 10, wherein a light spot of said laser projects laterally beyond said contact wire.

12. The method according to claim 10, wherein a diameter of a light spot of said laser is approximately twice as large as an irradiated width of said contact wire.

13. The method according to claim 10, wherein said light spot of said laser is defocused in its edge region and said energy input in said defocused edge region remains below an amount of energy input required for a soldering melting point.

14. The method according to claim 10, wherein said light spot of said laser is defocused in an edge region of approximately 10% to 20% of a radius of said light spot.

15. The method according to claim 1, wherein said strip-shaped contact region of said solar cell to which said contact wire is soldered is elongated and said contact wire is fixedly soldered thereto at a plurality of locations.

16. The method according to claim 15, wherein said plurality of locations has a distance of 1 cm to 2 cm each.

17. The method according to claim 1, wherein said contact wire is a tin-plated copper wire.

18. The method according to claim 1, wherein a contact wire is embodied as a flat wire having a width which amounts to a multiple of its thickness.

19. The method according to claim 18, wherein said width of said contact wire lies between 1 mm and 3 mm.

20. The method according to claim 19, wherein said width of said contact wire lies between 1.3 mm and 2.5 mm.
